(19) United States
(12) Patent Application Publication
(10) Pub. No.: US 2016/0217734 A1
(43) Pub. Date: Jul. 28, 2016

(54) COMPENSATION FOR COLOR VARIATIONS IN EMISSIVE DEVICES

(71) Applicant: Ignis Innovation Inc., Waterloo (CA)

(72) Inventor: Gholamreza Chaji, Waterloo (CA)

(21) Appl. No.: 15/004,398

(22) Filed: Jan. 22, 2016

(30) Foreign Application Priority Data
Jan. 23, 2015 (CA) 2,879,462

(51) Int. Cl. G09G 3/32; G09G 3/20

(52) U.S. Cl. CPC G09G 3/3225; G09G 3/2003; G09G 2300/0452; G09G 2320/0233; G09G 2320/0666

(57) ABSTRACT

What is disclosed are methods and systems for color compensation in the context of emissive displays. A set of virtual sub-pixels are defined and color points allocated for the various types of virtual sub-pixels to enable color processing within a modified color gamut, shifting the color of pixels to the modified color gamut to improve a perceived quality color rendered by the display.

### CROSS-REFERENCE TO RELATED APPLICATION(S)

This application claims priority to Canadian Application No. 2,879,462 which was filed Jan. 23, 2015, which is hereby incorporated by reference herein in its entirety.

### FIELD OF THE INVENTION

The present disclosure relates to color reproduction by emissive visual display technology, and particularly to color compensation for active matrix light emitting diode device (AMOLED) and other emissive visual displays.

### BRIEF SUMMARY

According to one aspect there is provided a method of color compensation for an emissive display comprising physical sub-pixels, the method comprising: defining a set of virtual sub-pixel types based on physical sub-pixel types, allocating a color point to each virtual sub-pixel type; performing color calculations with use of the color points of each virtual sub-pixel type to generate virtual sub-pixel brightness values; mapping virtual sub-pixel brightness values to physical sub-pixel values.

Some embodiments further provide for accumulating for each physical sub-pixel a physical sub-pixel value from contributions from mapping the virtual sub-pixel brightness values.

In some embodiments, the color point allocated to each virtual sub-pixel type is determined with use of measurements of the actual color points of the physical sub-pixels. In some embodiments, the measurements of the actual color points of physical sub-pixels comprises determining at least one non-uniformity for a threshold number of physical sub-pixels. In some embodiments, the color points allocated to the virtual sub-pixel types defines a color gamut smaller than a color gamut of pixels of the display exhibiting the greatest color accuracy. In some embodiments, the color points allocated to the virtual sub-pixel types are utilized in the mapping of virtual sub-pixel brightness values to physical sub-pixel values in order to reduce color nonuniformity across the emissive display.

According to another aspect there is provided a display system comprising: an emissive display comprising pixels each comprising physical sub-pixels, each pixel having a set of virtual sub-pixel types defined therefor based on the physical sub-pixels; an allocating module for allocating a color point to each virtual sub-pixel type; a color sharing module for calculating from display signal data the share of each virtual sub-pixel brightness with use of the color points of each virtual sub-pixel type to generate virtual sub-pixel brightness values; a mapping module for mapping virtual sub-pixel brightness values to physical sub-pixel values.

Some embodiment further provide for an accumulating module for accumulating for each physical sub-pixel a physical sub-pixel value from contributions from mapping the virtual sub-pixel brightness values.

In some embodiments, the allocating module is adapted to allocate each color point to each virtual sub-pixel type with use of measurements of the actual color points of the physical sub-pixels received from a measurement system. In some embodiments, the measurements of the actual color points of the physical sub-pixels comprises a determination of at least one non-uniformity for a threshold number of physical sub-pixels. In some embodiments, the color points allocated to the virtual sub-pixel types defines a color gamut smaller than a color gamut of pixels of the emissive display exhibiting the greatest color accuracy. In some embodiments, the color points allocated to the virtual sub-pixel types are utilized by the mapping module in mapping of virtual sub-pixel brightness values to physical sub-pixel values in order to reduce color nonuniformity across the emissive display.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates a set of virtual sub-pixels as defined by physical sub-pixels of a pixel of an emissive display according to an embodiment; and

FIG. 2 illustrates a data path for color processing by an emissive display system implementing virtual sub-pixels.

### DETAILED DESCRIPTION

Color reproduction and in particular color uniformity are important for today's emissive visual display technologies. Often due to imperfect manufacturing processes, device degradation, or simply due to spatially non-uniform use of a display, the color reproduction across the area of an emissive display may be non-uniform, affecting the user experience. It would be desirable for there to be methods of providing better color reproduction in the form of increased uniformity.

While the embodiments described herein will be in the context of AMOLED displays it should be understood that the embodiments described herein are applicable to any other emissive display comprising pixels each having a plurality of sub-pixels, including but not limited to liquid crystal displays (LCD), light emitting diode displays (LED), electroluminescent displays (ELD), organic light emitting diode displays (OLED), plasma display panels (PSP), among other displays.

It should be understood that the embodiments described herein pertaining to sub-pixel and pixel arrays, virtual pixel definition, and the management, mapping, calculation, and display of color thereof, do not limit the display technology underlying their operation and the operation of the displays in which they are implemented. Implementation of various types of visual display technologies for designing, manufacturing, and driving the displays comprising the sub-pixels and pixels, as well as the operational details of standard management, mapping, calculation, and display of color thereof, are well beyond the scope of this document but are nonetheless known to persons having skill in the art.

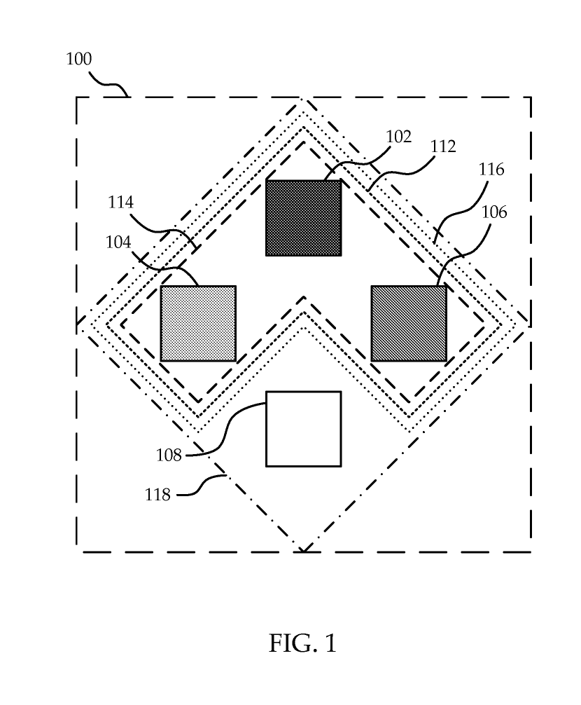

Referring to FIG. 1, a pixel 100 of an emissive display and its physical sub-pixels as well as the virtual sub-pixels (also referred to as hybrid sub-pixels) defined thereby in accordance with an embodiment will now be discussed.

The pixel 100 illustrated in FIG. 1 is one of an array of many pixels of an AMOLED (not shown), is comprised of a plurality of physical sub-pixels 102, 104, 106, 108, each of a different type which is responsible for providing a component, channel, or color of the pixel. In an AMOLED, each physical sub-pixel comprises an organic light emitting diode (OLED) having the material appropriate for generation of the component, channel or color contributed by the physical sub-pixel. The pixel 100 of FIG. 1, is composed of four physical sub-pixels 102, 104, 106, 108. Each of the four physical sub-pixels are of a different type, namely, red (R) 102, green (G) 104, and blue (B) 106, represented in shades of grey in no particular order, as well as white (W) 108. Although the pixel 100 of the embodiment possesses four types of physical sub-pixels, R, G, B, and W, pixels of any number of types of physical sub-pixels Np are contemplated. For accurate reproduction of a broad color gamut perceivable to the human eye, it is expected that most systems will employ three or more types of physical sub-pixel.

In accordance with an embodiment, a set of hybrid sub-pixels (hereinafter referred to as virtual sub-pixels) is defined based on the set of physical sub-pixels. Each virtual sub-pixel is defined as including one or more physical sub-pixels, each defining a type of virtual sub-pixel even when the one or more physical sub-pixels making it up are not unique. For example, in FIG. 1, for pixel 100, a first virtual sub-pixel is defined as including the R, G, and B physical sub-pixels, hereinafter labeled as Rv, and is referred to as a “red” virtual sub-pixel 112, a second type of virtual sub-pixel, a “blue” virtual pixel 116, hereinafter labeled By, is also defined as including the R, G, and B physical sub-pixels. In the embodiment depicted in FIG. 1, a third type of virtual sub-pixel, a “green” virtual sub-pixel 114, hereinafter labelled Gv is also defined as including the R, G, and B physical sub-pixels, while a fourth type of virtual sub-pixel, a “white” virtual sub-pixel 118, hereinafter labelled Wv is defined as including all of R, G, B, and W physical sub-pixels.

The total number of virtual sub-pixel types Nv, which as shown further below characterizes a virtual color space for purposes of color compensation, can be greater than, smaller than, or equal to the number of physical sub-pixel types Np.

It should be understood from the above that each pixel 100 has a set of virtual sub-pixels 112, 114, 116, 118 defined therefor, each having a defined type, and each including a subset of physical sub-pixels 102, 104, 106, 108 of the pixel 100.

Once a set of virtual sub-pixels has been defined in accordance with the above, each type of virtual sub-pixel is allocated a color point for that type which will serve in calculations involving all virtual sub-pixels of that type. Assigning a color point for each virtual sub-pixel type essentially defines a virtual color space for all of the pixels, for which some color management and compensation calculation can take place on the basis of the virtual sub-pixels rather than the physical sub-pixels.

In one example embodiment, the light output of the AMOLED is tested, measured, or otherwise characterized. This may be on a pixel by pixel basis or on a less granular level. Overall uniformity, average or systematic color error, and color accuracy among a whole host of other metrics may be measured. The color points are chosen for each type of virtual sub-pixel based on a number of considerations, some of which are: resulting color uniformity, color accuracy, perceptual considerations, etc. Often a compromise must be struck between considerations such as color uniformity and color accuracy because compensation is still restricted by the physical limitations of the actual physical sub-pixels.

In one embodiment, each type of physical sub-pixel is tested for color variation across the display, for example the R physical sub-pixels. Then, from data regarding the errors measured in the generation of red color by, for example, an appreciable number of red physical sub-pixels leading to a major contribution to the nonuniformity in red, a color point is chosen for the red type virtual sub-pixels. The color point is chosen within certain limits set by perceptual considerations, acceptable deviations from color accuracy, among others. For example, a large number of red physical sub-pixels (possibly a threshold number of them) may have a measured color that is less saturated than the rest of the red physical sub-pixels. Therefore, to achieve a color uniformity, those pixels possessing the red physical sub-pixels having saturated color will need to be tuned by adding color from other physical sub-pixels. For example, the pixels possessing the saturated red physical sub-pixels will be combined with green and blue which is emitted from those pixels' green and blue physical sub-pixels. In one example, the ratio can be (R, G, B)=(80, 19, 1), expressed in channel intensities ranging from 0-100. In this example, to show 100 nit red brightness, 80 nit will be generated by saturated red, 19 nit by green and one nit by blue to match the 100 nit brightness from unsaturated red.

A similar procedure for other physical sub-pixels (e.g. green, blue, and white) would be performed. It should be noted that the color space into which the actual measurements of the display are translated as well as the color points allocated to each type of virtual sub-pixel are independent of the definition of each virtual sub-pixel. For example, although the white virtual sub-pixel is defined as including R, G, B, and W physical sub-pixels, its allocated color point is preferably expressed in the same color space as that defined for the other virtual sub-pixels for ease of calculation, which in this example is R, G, B.

In one embodiment, the color points chosen define for the virtual sub-pixels a virtual color space in the color coordinates of the starting color space. In the example application of providing better color uniformity, this virtual color space is generally of a reduced color gamut compared to what the best pixels of the display can produce. In this application, the purpose of the virtual sub-pixels and the virtual color space is to create greater perceived color uniformity by restraining or mapping the majority of wider gamut and/or accurate pixels to a reduced or skewed gamut defined by the large number of pixels having greater color inaccuracies.

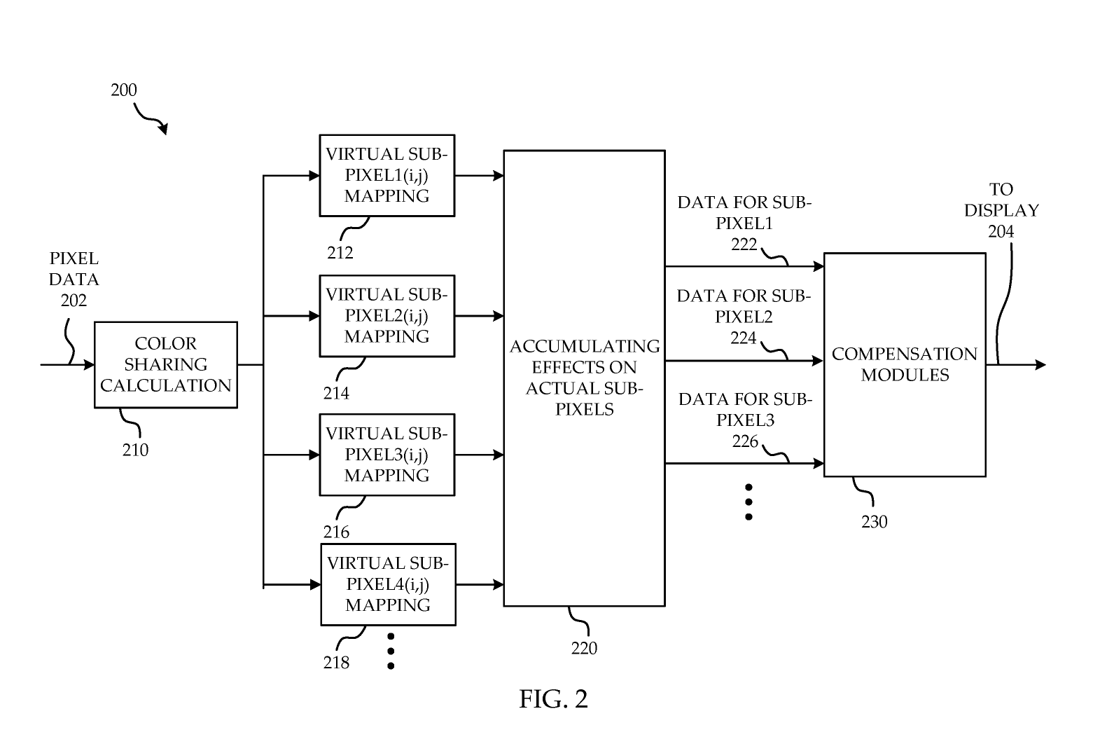

With reference to FIG. 2 also, pixel data for display 202 is input to a color sharing block 210 which as understood by skilled persons in the art, performs a number of color management, translation, etc. calculations in order to ensure that the data, in whatever color space it is defined, is properly translated for the particular display, its color space, number and types of sub-pixels. In known applications, color sharing calculations 210 directly create data for physical sub-pixels of the display which optionally can go through compensation modules 230 prior to being sent to the display 204. In the absence of virtual sub-pixels, these modules perform their calculations according to standard color spaces and information regarding the physical display only. In the embodiment depicted in FIG. 2, the color sharing calculation 210 is modified to perform as though the actual sub-pixels of the display were the virtual sub-pixels as defined above, and as though the color gamut capable of the display were that as defined by the color points allocated to the various types of virtual sub-pixels as described above. Other than using a virtual display characterized by virtual sub-pixels and a virtual color space, the color sharing calculation block performs the kind of calculations it normally would have performed in other color data mapping applications. The color sharing block 210 calculates the share of each virtual sub-pixel in creating the color and brightness of a display signal, performing this calculation with use of the color points of each virtual sub-pixel type to generate the virtual sub-pixel brightness values.

Out of the color sharing calculation 210 come the various brightness values for each pixel in terms of its virtual sub-pixels, e.g. Rv, Gv, By, Wv, each specifying the intensity each virtual sub-pixel should have to reproduce the desired color for the pixel. This virtual color needs to be translated back into data which can drive the physical sub-pixels of the display. This task is performed by a combination of virtual sub-pixel mapping 212, . . . , 218 and sub-pixel accumulation 220, which may be combined into one calculation.

FIG. 2, illustrates the mapping for a pixel at the ith row and jth column (i,j), which includes mapping each of the types of virtual sub-pixels into values for the physical sub-pixel at the ith row and jth column. The mapping of the virtual brightness values back into the intensities of the physical sub-pixels has been broken up on a pixel by pixel basis (shown is the mapping for pixel (i,j)) and on a virtual sub-pixel type basis. In the example depicted in FIG. 2, virtual sub-pixel 1, virtual sub-pixel 2, virtual sub-pixel 3, and virtual sub-pixel 4, correspond to the red, green, blue, and white virtual sub-pixels. If the color value for a pixel emerging from the color sharing block 210 were (Rv, Gv, By, Wv) “intensities” for each of the virtual sub-pixels, then virtual sub-pixel 1 mapping 212 would be utilized to translate the (Rv, Gv, Bv, Wv) into appropriate physical sub-pixel intensities (R,G,B,W) taking into the color point allocated to the virtual sub-pixels and the physical sub-pixel color point. In one case, there might be more than one combination to map a virtual sub-pixel to physical sub-pixels. Here, other factors such as reliability, power consumption, and visual effects can be used to select a proper mapping form viable cases.

In one embodiment, at the accumulation stage, for any given pixel (i,j), the effects on actual physical sub-pixels is accumulated from all of the virtual sub-pixels as mapped in the mapping step above. For example, each of the red, green, blue, and white virtual sub-pixel includes intensities (including possibly the 0 value) for each of the R, G, and B physical sub-pixels, and the white virtual sub-pixel includes intensities for the all of the types R, G, B, and W of physical sub-pixels. In the result, each of the physical sub-pixels R, G, B, and W, may have contributions of intensity from any or all of the Rv, Gv, By, and Wv virtual sub-pixel values. The brightness value of virtual sub-pixels can be in the linear domain (e.g. actual or normalized brightness) or a non-linear domain (e.g. gray scales). In the case of the linear domain, the total value for each physical sub-pixel will be the summation of the effects from each virtual sub-pixel on the brightness of the physical sub-pixel. In the case of a non-linear domain, other functions are used to calculate the total value for each physical sub-pixel.

Once the data contributed from each of the virtual sub-pixels has been accumulated for a physical pixel, data for each physical sub-pixel 222, 224, 226, etc. is output to the next block, typically compensation modules 230.

There are other calculations which can be performed in the virtual sub-pixel domain as well, for example, gamma correction, high dynamic range adjustment, and other processes. Also, other operations can be performed after converting to physical sub-pixels value.

In the final compensation stage 230, color correction and compensation for aging, non-uniformity, and other issues can be performed prior to the final pixel data's being sent to the display 204.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method of color compensation for an emissive display comprising physical sub-pixels, the method comprising:
defining a set of virtual sub-pixel types based on physical sub-pixel types,
allocating a color point to each virtual sub-pixel type;
performing color calculations with use of the color points of each virtual sub-pixel type to generate virtual sub-pixel brightness values;
mapping virtual sub-pixel brightness values to physical sub-pixel values.

2. The method of claim 1 further comprising accumulating for each physical sub-pixel a physical sub-pixel value from contributions from mapping the virtual sub-pixel brightness values.

3. The method of claim 2 wherein the color point allocated to each virtual sub-pixel type is determined with use of measurements of the actual color points of the physical sub-pixels.

4. The method of claim 3 wherein the measurements of the actual color points of physical sub-pixels comprises determining at least one non-uniformity for a threshold number of physical sub-pixels.

5. The method of claim 3 wherein the color points allocated to the virtual sub-pixel types defines a color gamut smaller than a color gamut of pixels of the display exhibiting the greatest color accuracy.

6. The method of claim 3 wherein the color points allocated to the virtual sub-pixel types are utilized in the mapping of virtual sub-pixel brightness values to physical sub-pixel values in order to reduce color nonuniformity across the emissive display.

7. A display system comprising:
an emissive display comprising pixels each comprising physical sub-pixels, each pixel having a set of virtual sub-pixel types defined therefor based on the physical sub-pixels;
an allocating module for allocating a color point to each virtual sub-pixel type;
a color sharing module for calculating from display signal data the share of each virtual sub-pixel brightness with use of the color points of each virtual sub-pixel type to generate virtual sub-pixel brightness values;
a mapping module for mapping virtual sub-pixel brightness values to physical sub-pixel values.

8. The display system of claim 7 further comprising an accumulating module for accumulating for each physical sub-pixel a physical sub-pixel value from contributions from mapping the virtual sub-pixel brightness values.

9. The display system of claim 8 wherein the allocating module is adapted to allocate each color point to each virtual sub-pixel type with use of measurements of the actual color points of the physical sub-pixels received from a measurement system.

10. The display system of claim 9 wherein the measurements of the actual color points of the physical sub-pixels comprises a determination of at least one non-uniformity for a threshold number of physical sub-pixels.

11. The display system of claim 9 wherein the color points allocated to the virtual sub-pixel types defines a color gamut smaller than a color gamut of pixels of the emissive display exhibiting the greatest color accuracy.

12. The display system of claim 9 wherein the color points allocated to the virtual sub-pixel types are utilized by the mapping module in mapping of virtual sub-pixel brightness values to physical sub-pixel values in order to reduce color nonuniformity across the emissive display.
